(19) United States
(12) Patent Application Publication
(10) Pub. No.: US 2013/0265242 A1
(43) Pub. Date: Oct. 10, 2013

(54) TOUCH SENSOR COMMON MODE NOISE RECOVERY

(71) Applicants: Peter W. Richards, San Francisco, CA (US); Christoph Horst Krah, Los Altos, CA (US); Martin Paul Grunthaner, Mountain View, CA (US)

(72) Inventors: Peter W. Richards, San Francisco, CA (US); Christoph Horst Krah, Los Altos, CA (US); Martin Paul Grunthaner, Mountain View, CA (US)

(21) Appl. No.: 13/442,709

(22) Filed: Apr. 9, 2012

(51) Int. Cl. G06F 3/041

(52) U.S. Cl. 345/173

(57) ABSTRACT

A touch sensor panel configured to minimize the effect on touch or proximity event detection caused by a common mode noise event. The touch sensor panel includes circuitry that works to minimize the amount of time that the touch sensor panel is unable to accurately sense touch and proximity events due to a common mode noise event. The touch sensor panel can also re-acquire data that was collected during the time that the sensor panel was unable to accurately detect touch and proximity events, when a common mode noise event is detected.

### FIELD OF THE DISCLOSURE

This relates generally to minimizing the effects that common mode noise has upon the fidelity of touch signals on a touch input device.

### BACKGROUND OF THE DISCLOSURE

Many types of input devices are available for performing operations in a computing system, such as buttons or keys, mice, trackballs, joysticks, touch sensor panels, touch screens, and the like. Touch screens, in particular, are becoming increasingly popular because of their ease and versatility of operation as well as their declining price. Touch screens can include a touch sensor panel, which can be a clear panel with a touch-sensitive surface, and a display device such as a liquid crystal display (LCD) that can be positioned partially or fully behind the panel so that the touch-sensitive surface can cover at least a portion of the viewable area of the display device. Touch screens generally allow a user to perform various functions by touching (e.g., physical contact or near-field proximity) the touch sensor panel using a finger, stylus or other object at a location often dictated by a user interface (UI) being displayed by the display device. In general, touch screens can recognize a touch event and the position of the touch event on the touch sensor panel, and the computing system can then interpret the touch event in accordance with the display appearing at the time of the touch event, and thereafter can perform one or more actions based on the touch event.

Mutual capacitance touch sensor panels can be formed from a matrix of drive and sense lines of a conductive material such as Indium Tin Oxide (ITO). The lines are often arranged orthogonally on a substantially transparent substrate. The drive and sense lines can have a mutual capacitance between them that can be altered when an object touches the touch sensor panel. This change in mutual capacitance is used to detect the presence of a touch. The drive and sense lines, however, can be susceptible to external noise created by proximate electrical components, which can be coupled onto the touch sensor panel via parasitic capacitance paths (referred to as common mode noise) created on the drive and sense lines. This external noise can degrade the ability of the touch sensor panel to detect touch and proximity events. Proximate electrical components on the device can be designed to minimize the emission of signals that, when coupled onto the touch sensor panel, can degrade touch performance. However, proximate electrical components which are attached to the device by a user, such as a power adapter, may not be designed to prevent the emission of signals strong enough to degrade touch signal fidelity.

### SUMMARY OF THE DISCLOSURE

This relates to a touch panel configured to compensate for degradation in touch detection caused by the effects of common mode noise coupled into the panel from proximate electronics. The panel can be configured to include circuitry which, when a possible operational amplifier saturation event is occurring, can act to return the touch sensor panel into an operational state quickly, thus minimizing the impact that a common mode noise event has on a touch sensor panel. Furthermore, the scan logic associated with the touch sensor panel can work to re-acquire touch data that was collected during a possible operational amplifier saturation event, thereby further minimizing the impact that a common mode noise event has on a touch sensor panel.

### BRIEF DESCRIPTION OF THE DRAWINGS

FIG. 1 illustrates an exemplary mutual capacitance touch sensor panel according to one disclosed embodiment.

FIG. 2 illustrates an exemplary touch sensor panel sense circuit according to one disclosed embodiment.

FIG. 3 illustrates an exemplary plot of various signals of the touch sensor panel sense circuit according to one disclosed embodiment.

FIG. 4a illustrates an exemplary sense circuit amplifier with a clamping circuit according to one disclosed embodiment.

FIG. 4b illustrates yet another exemplary sense circuit amplifier with a clamping circuit according to one disclosed embodiment.

FIG. 5 illustrates an exemplary plot of various signals of the touch sensor panel sense circuit with a clamping circuit according to one disclosed embodiment.

FIG. 6a illustrates an exemplary sense circuit amplifier with a switchable resistor according to one disclosed embodiment.

FIG. 6b illustrates yet another exemplary sense circuit amplifier with a switchable resistor according to one disclosed embodiment.

FIG. 7 illustrates an exemplary plot of various signals of the touch sensor panel sense circuit with a switchable resistor according to one disclosed embodiment.

FIG. 8 illustrates an exemplary touch sensor panel control system according to one disclosed embodiment.

FIG. 9 illustrates an exemplary touch data organization scheme according to one disclosed embodiment.

FIG. 10a illustrates one exemplary method of correcting touch data according to one disclosed embodiment.

FIG. 10b illustrates yet another exemplary method of correcting touch data according to one disclosed embodiment.

FIG. 11 illustrates an exemplary computing system including a touch sensor panel utilizing touch sensor common mode noise recovery according to one disclosed embodiment.

FIG. 12a illustrates an exemplary mobile telephone having a touch sensor panel that includes a touch common mode noise recovery circuit and method according to one disclosed embodiment.

FIG. 12b illustrates an exemplary digital media player having a touch sensor panel that includes a touch common mode noise recovery circuit and method according to one disclosed embodiment.

FIG. 12c illustrates an exemplary personal computer having a touch sensor panel that includes a touch common mode noise recovery circuit and method according to one disclosed embodiment.

### DETAILED DESCRIPTION

In the following description of embodiments, reference is made to the accompanying drawings which form a part hereof, and in which it is shown by way of illustration specific embodiments that can be practiced. It is to be understood that other embodiments can be used and structural changes can be made without departing from the scope of the disclosed embodiments.

This relates to the suppression of common mode noise on a touch sensor panel and the mitigation of effects of common mode noise on a touch sensor panel. The presence of common mode noise can be detected by the touch sensor panel. The detected presence of common mode noise on a touch signal can trigger circuitry within the touch sensor panel to “clamp” the incoming touch signal, so as to minimize the adverse effects to the operation of touch signal sense circuitry. In other disclosed embodiments, the detected presence of common mode noise on a touch signal can trigger circuitry with the touch sensor panel to help the touch sensor panel recover more quickly from the adverse effects of common mode noise on a touch signal.

Furthermore, the effect of common mode noise on touch detection can be mitigated by ensuring that touch data was not collected during a common mode noise event. This can be achieved by reacquiring touch data potentially corrupted by common mode noise when the presence of common mode noise is detected.

Although embodiments disclosed herein may be described and illustrated herein in terms of mutual capacitance touch sensor panels, it should be understood that the embodiments are not so limited, but are additionally applicable to self-capacitance sensor panels, and both single and multi-touch sensor panels in which common mode noise can affect the fidelity of touch detection. Also, although embodiments disclosed herein refer to a specific hardware architecture to achieve mutual capacitance touch detection, it should be understood that the embodiments are not so limited, but may be additionally applicable to any hardware architecture capable of detecting touch or proximity events using either mutual capacitance or self capacitance. Also, although embodiments disclosed herein refer to a single stimulation architecture and data collection method, it should be understood that the embodiments are not so limited, but maybe be additionally applicable to a multiple stimulation architecture and data collection method in which multiple lines are stimulated simultaneously and the data for the multiple rows is collected simultaneously. Furthermore, although embodiments disclosed herein relate to a method of mitigating the effects of common mode noise on a touch sensor panel, it should be understood that the embodiments are not so limited, but may be additionally applicable to any capacitive touch sensor device such as a capacitive trackpad.

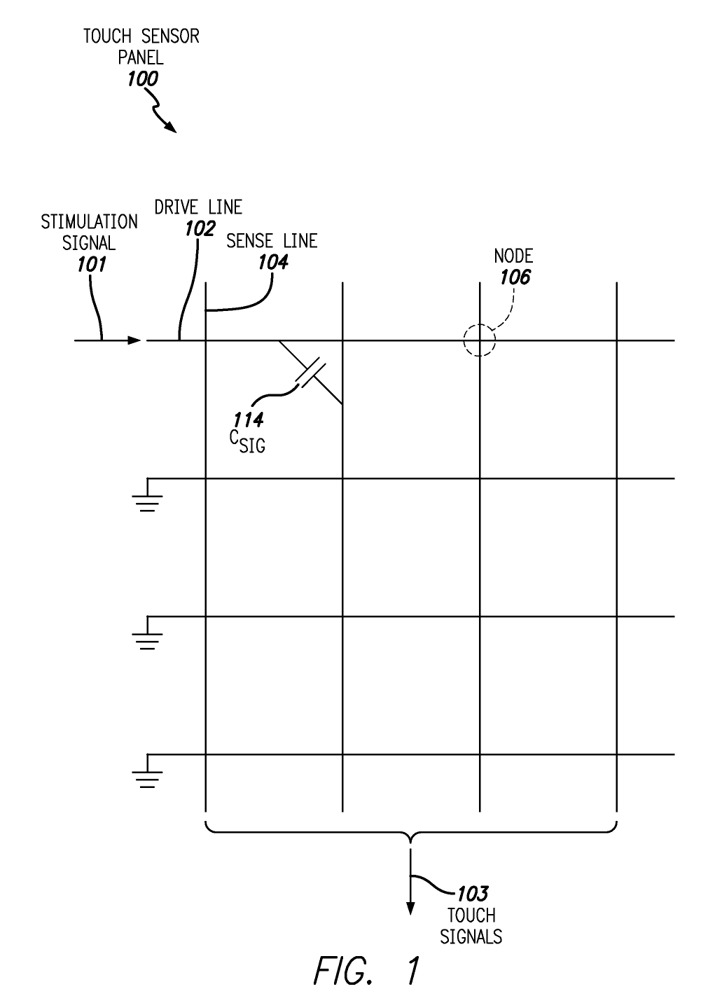

FIG. 1 illustrates an exemplary mutual capacitance touch sensor panel according to one disclosed embodiment. Touch sensor panel 100 can include an array of touch nodes 106 that can be formed at the crossing points of row lines 102 and column lines 104. Each pixel 106 can have an associated mutual capacitance Csig 114 formed between the crossing row lines 102 and column lines 104. As illustrated in FIG. 1, the row lines 102 can function as drive lines and the column lines 104 can function as sense lines, where the drive lines can be stimulated by stimulation signals 101 provided by drive circuitry (not shown) that can include an alternating current (AC) waveform and the sense lines can transmit touch or sense signals 103, indicative of a touch at the panel 100, to sense circuitry (not shown) that can include a sense amplifier for each sense line.

To sense a touch at the panel 100, in some embodiments, multiple drive lines 102 can be substantially simultaneously stimulated by the stimulation signals 101 to capacitively couple with the crossing sense lines 104, thereby forming capacitive paths for coupling charge from the drive lines to the sense lines. The crossing sense lines 104 can output signals representing the coupled charge or current. While some drive lines 102 are being stimulated, the other drive lines can be coupled to ground or other reference voltage. In other embodiments, each drive line 102 can be sequentially stimulated by the stimulation signals 101 to capacitively couple with the crossing sense lines 104, which can output signals representing the coupled charge or current, while the other drive lines can be coupled to ground or other reference voltage. In still other embodiments, there can be a combination of multiple drive lines 102 being substantially simultaneously stimulated and single drive lines being sequentially stimulated.

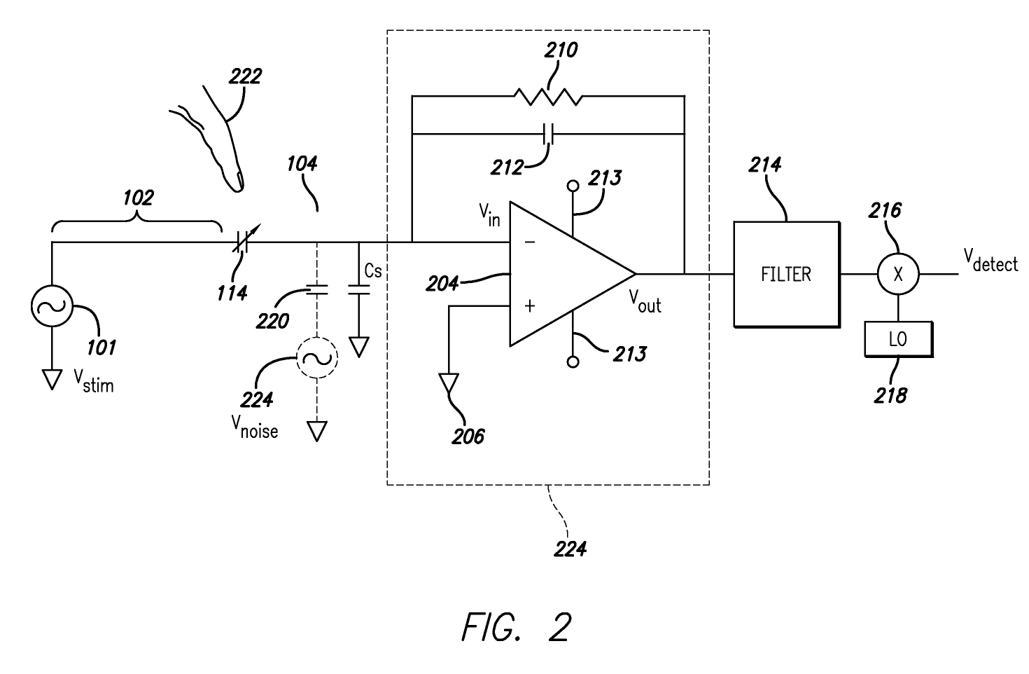

FIG. 2 illustrates an exemplary touch sensor panel sense circuit according to one disclosed embodiment. Drive line 102 can be stimulated by stimulation signal 101. Stimulation signal 101 can be capacitively coupled to sense line 104 through the mutual capacitance 114 between drive line 102 and the sense line. When a finger or object 222 approaches the touch node created by the intersection of drive line 102 and sense line 104, the mutual capacitance 114 can be altered. This change in mutual capacitance 114 can be detected to indicate a touch or proximity event. The sense signal coupled onto sense line 104 is then received by sense amplifier 224. Sense amplifier 224 can include operational amplifier 204, and at least one of a feedback resistor 210 and a feedback capacitor 212. FIG. 2 is shown for the general case in which both resistive and capacitive feedback elements are utilized. The sense signal can be inputted into the inverting input (referred to as Vin) of the operational amplifier 204, and the non-inverting input can be tied to a reference voltage Vref 206. The operational amplifier 204 adjusts its output voltage to keep Vin equivalent to Vref and therefore keep Vin constant or virtually grounded as to reject stray capacitance Cs or any change thereof. Therefore, the gain of the amplifier is mostly a function of the ratio of the signal capacitance 114 and the feedback impedance, comprised of resistors 210 and capacitor 212. The output of sense amplifier 224 Vout can be further filtered and heterodyned or homodyned by being fed into a multiplier 216, and multiplied with a local oscillator 218 to produce Vdetect. One skilled in the art will recognize that the placement of filter 214 can be varied, and thus could be placed after multiplier 216, or two filters can be employed, one before the mixer and one after the mixer. In some embodiments, there can be no filter at all. The direct current (DC) portion of Vdetect can be used to detect if a touch or proximity event has occurred.

Parasitic capacitance path 220 can be created by various interactions between the sense line 104 and components within the touch input device, or external to the touch input device. Due to the existence of parasitic capacitance path 220, electrical signals generated in other components of the touch input device (herein referred to as Vnoise 224) can be coupled onto sense line 104. Typically, Vnoise (also referred to as common mode noise) is a signal that can arise suddenly and is present for a short duration on the order of 50 to 200 μs. This characteristic of Vnoise can result in a degradation of the touch sense circuitry's ability to detect touch and proximity events. For instance one negative result of signal Vnoise being coupled onto sense line 104 is that the signal has the potential to cause operational amplifier 204 to saturate. Operational amplifier 204 is said to saturate when the amplifier is no longer able to provide sufficient output voltage to the incoming signal in order to keep the voltage Vin at the inverting input of the amplifier equal to Vref 206 at the non-inverting input. Generally operational amplifier 204 is constrained by the dynamic output voltage range Voutpp and the feedback impedance Zfb. More specifically, when the input signal current into the inverting pin of the operational amplifier exceeds Voutpp/Zfb the operational amplifier 204 is operating under a saturation condition, and therefore is unable to detect changes in mutual capacitance 114 caused by a finger or object 222, and thus cannot reliably detect touch or proximity events.

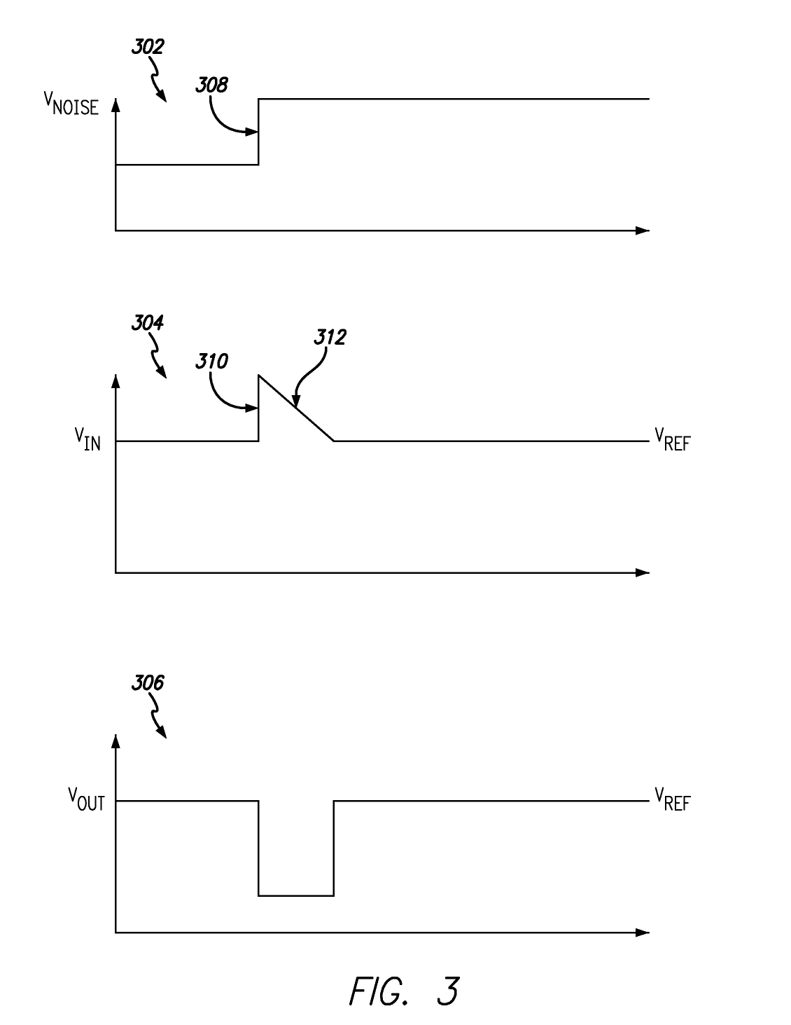

FIG. 3 illustrates an exemplary plot of various signals vs. time of the touch sensor panel sense circuit according to one disclosed embodiment. When Vnoise 224 produces a signal like that of plot 302, the signal can capacitively couple onto the sense line 104 via parasitic capacitance path 220. As shown in plot 302, Vnoise can rise nearly instantaneously (for instance <10 μs), creating a positive edge 308. While a change in Vnoise is illustrated as a positive edge, one skilled in the art will recognize that Vnoise can also fall in level to create a negative edge. When Vnoise 224 is capacitively coupled onto sense line 104 via parasitic capacitance path 220, Vin can appear as plotted in plot 304. Since the relationship between Vnoise and the signal which appears on the sense line due to parasitic capacitance path 220 can be expressed as being proportional to the derivative of Vnoise, Vin can experience a nearly instantaneous spike 310 in its level as illustrated in plot 304. This nearly instantaneous spike 310 can cause operational amplifier 204 to operate in saturation if the instantaneous spike 310 is of a magnitude great enough such that the operation amplifier can no longer provide enough output voltage to maintain Vin equal to Vref as is the case when the operational amplifier is operating at non-saturation. Slope 312 of plot 304 represents the amount of time operational amplifier 204 takes to recover from a saturation condition. Operational amplifier 204 can be said to recover from a saturation condition when the value of Vin is returned to Vref. Thus, it is desired that slope 312 is steep, meaning that the time between when operational amplifier 204 goes into saturation and the time when Vin returns to Vref is small. When Vin is not equivalent to Vref, Vout can be altered as expressed in plot 306. When Vout is altered as it is in plot 306, a touch signal may no longer be detected.

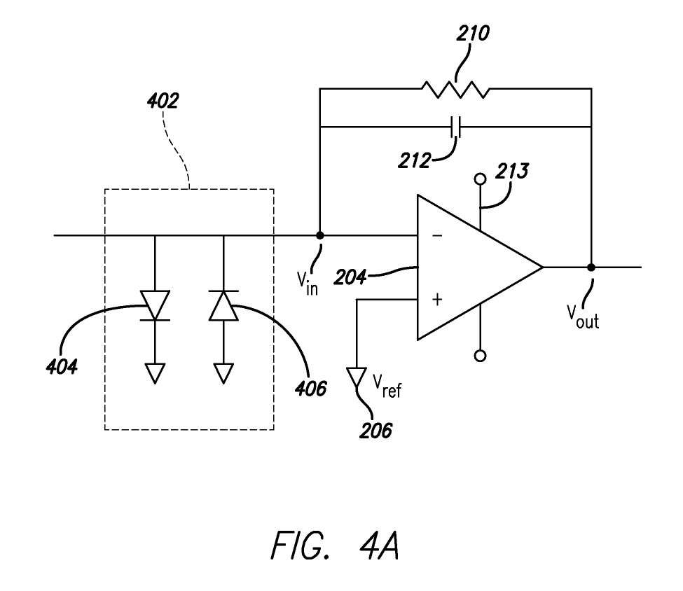

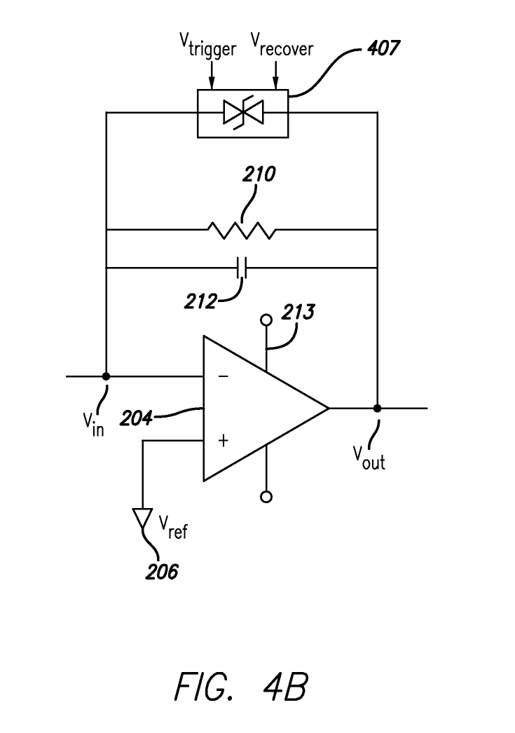

According to one disclosed embodiment, one method of reducing the effect that noise coupled through parasitic capacitance path 220 can have on touch detection is to employ a clamping circuit. FIG. 4 illustrates an exemplary sense circuit amplifier with a clamping circuit according to one disclosed embodiment. Clamping circuit 402 can contain two diodes 404 and 406 whose anode and cathode are oriented in opposite directions. The diodes 404 and 406 of clamping circuit 402 can be selected such that when Vin deviates from Vref by a certain amount, one of the diodes will begin forward conduction and cause current to flow through the diode. Clamping circuit 402 can allow the touch sensor panel to detect a possible saturation event on Vin simply by the diode beginning forward conduction in response to a voltage level greater in magnitude than its turn on voltage. For instance, if Vin is greater than Vref, then diode 404 will begin forward conduction and current will flow through it, so long as Vin is greater than the turn on voltage of diode 404. If Vin is less than Vref, then diode 406 will begin forward conduction and current will flow through it, so long as potential across diode 406 is greater than the turn on voltage of the diode.

FIG. 4B shows yet another implementation that overcomes the limitations of the input clamp described in FIG. 4A, namely that the operation amplifier may still saturate. When the amplifier saturates, the amplifiers AC response becomes open loop (i.e. the feedback capacitor no longer able to maintain virtual ground for a dynamic signal since the operational amplifiers output is in saturation). Therefore, the amplifier's output may remain in saturation until the feedback resistor has charged the stray capacitor Cs on the non-inverting input of the operational amplifier until it reaches the reference voltage level 206. In order to prevent the amplifier from saturating, a feedback clamp is added to the feedback path of the operational amplifier 204. The feedback clamp can have a trigger threshold Vtrigger and a recovery threshold Vrecover. When the dynamic output voltage of amplifier 204 exceeds the trigger threshold voltage, the feedback clamp starts conducting lowering the feedback impedance and therefore allowing the operational amplifier to absorb more noise while remaining in regulation. Once the output of the amplifier drops below a set recovery threshold Vrecover, the clamp is released. Vtrigger and Vrecover may be programmable or static. The advantage of this implementation over the implementation in FIG. 4a is that the amplifier may not saturate depending of the impedance of the feedback clamp, therefore can recover more quickly than in the previous implementation.

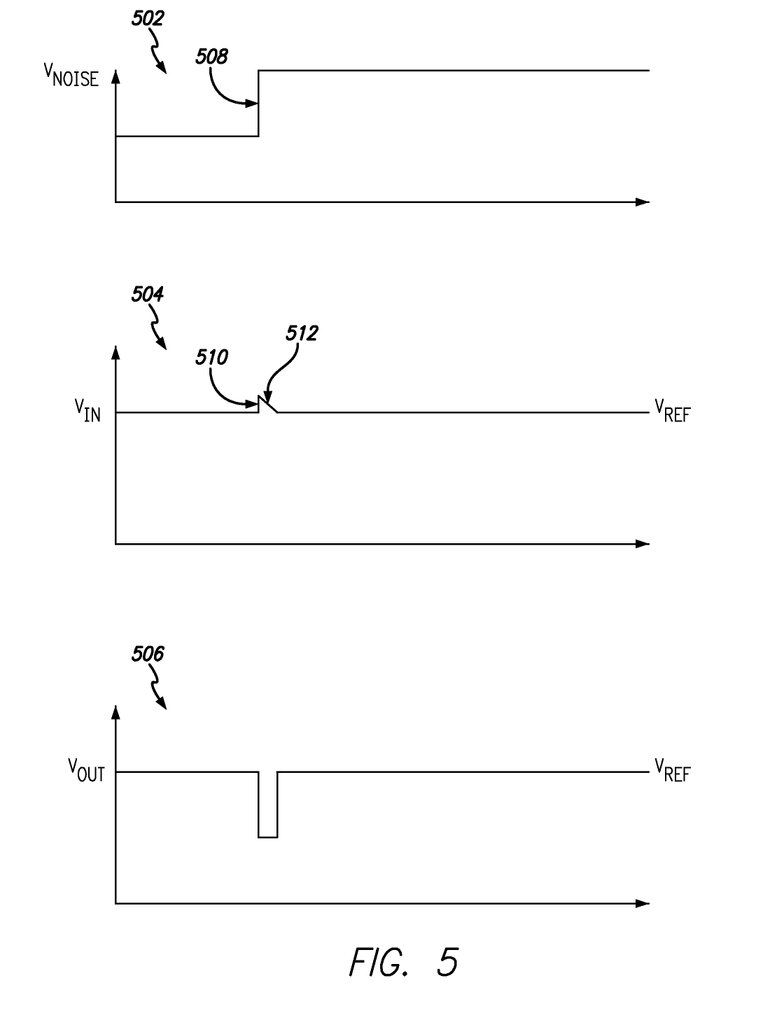

The effect of the clamping circuit can be illustrated in FIG. 5. FIG. 5 illustrates an exemplary plot of various signals of the touch sensor panel sense circuit with a clamping circuit according to one disclosed embodiment. Plot 502 represents Vnoise as a function of time. Similar to plot 302 of FIG. 3, Vnoise can experience a nearly instantaneous rise in level, which can create a positive edge 508. Like FIG. 3, changes in Vnoise are not confined to instantaneous rises, but can also be characterized by instantaneous falls in signal levels, or even gradual decreases and increases in signal level. Plot 504 represents the corresponding Vin for operational amplifier 204. The positive edge 508 of plot 502 can create a nearly instantaneous spike 510 in Vin. However, when Vin begins to spike, clamping circuit 402 can become engaged when the level of Vin becomes greater than the forward conduction voltage of diode 404. Thus, the instantaneous spike in Vin can be effectively “clamped,” meaning its level is not allowed to rise above a certain level. This clamping of Vin can indicate that operational amplifier 204 is either not saturated at all, or is only is only mildly saturated. Slope 512 can be steep when compared to slope 312 of plot 304. A steeper slope 512 can indicate that operational amplifier 204 can recover from saturation faster and the disruption to touch detection can be for a shorter duration. Plot 506 shows that the disruption to Vout can be minimal, since operational amplifier 204 can return to a normal state quicker due to clamping circuit 402.

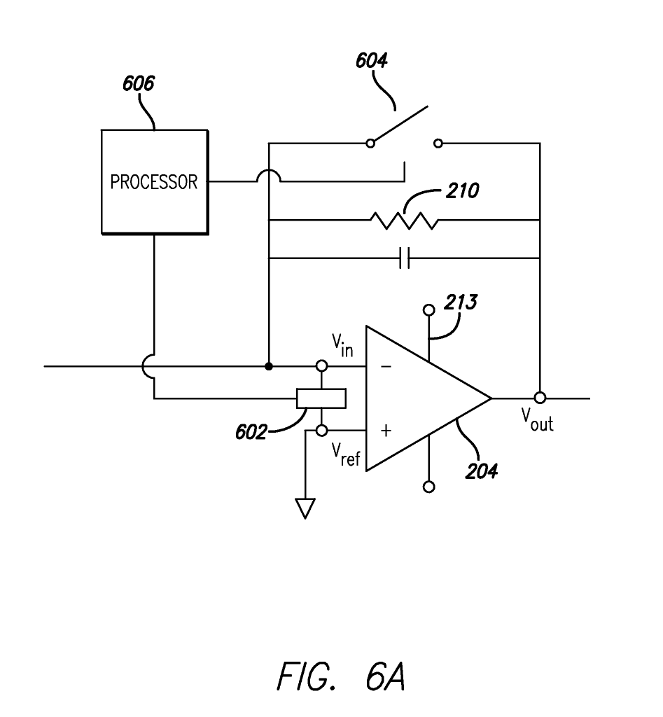

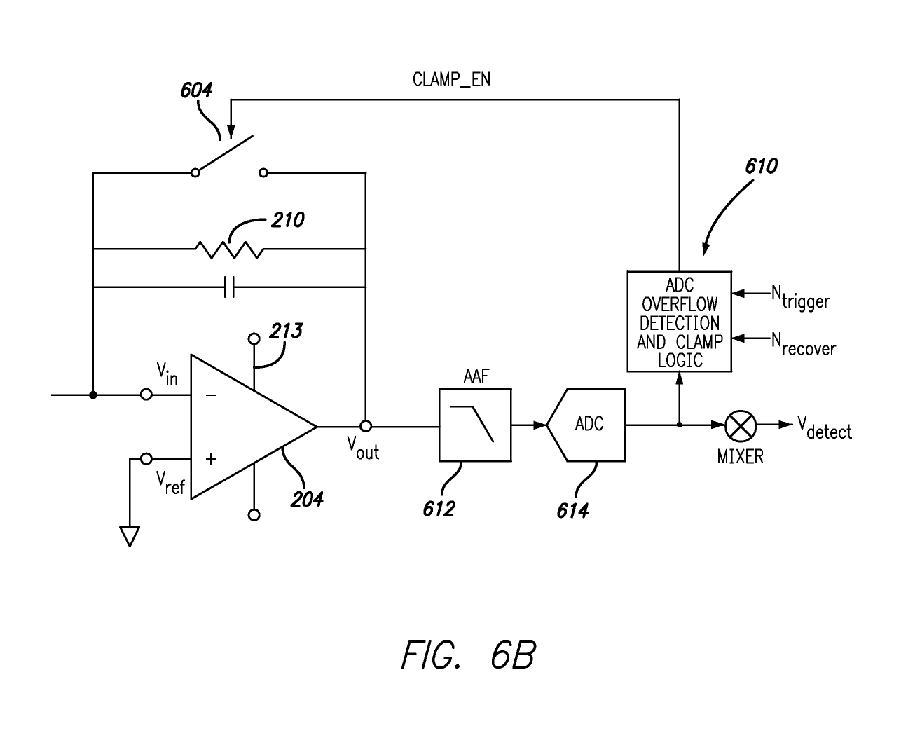

FIG. 6 illustrates an exemplary sense circuit amplifier with a switchable resistor according to one disclosed embodiment. Operational amplifier 204 can be outfitted with a comparator circuit 602 whose function is to compare the signal level of Vin with the signal level of Vref. One skilled in the art will recognize that a comparator circuit 602 can be implemented in numerous ways including but not limited to op amp based voltage comparators, chip based voltage comparators, and Schmitt trigger based voltage comparators. Furthermore, the placement of comparator circuit 602 as illustrated in FIG. 6 is shown for example purposes only. Comparator 602 can be placed anywhere within the touch sensing circuit where a deviation of Vin from Vref can be detected. For instance, comparator circuit 602 can be placed such that it compares Vout to the supply voltage 213. If Vout approaches or is close to supply voltage 213, then that can be indicative of a saturation event. A deviation of Vin from Vref can be indicative of an imminent noise event which can saturate operational amplifier 204. Comparator circuit 602 can be configured such when Vin deviates from Vref above a certain pre-determined threshold, the comparator circuit sends a signal to touch processor 606. The pre-determined threshold value can be selected according to the saturation characteristics of operational amplifier 204. In one disclosed embodiment, Vout can be digitized using an analog to digital converter. When the analog to digital converter registers a signal that is close to its maximum or minimum possible output value, a possible saturation event can be occurring.

When comparator circuit 602 indicates to processor 606 that a potential noise event is occurring, touch processor 606 can engage switch 604. When switch 604 is engaged, resistor 606 is placed in parallel with feedback resistor 210. The value of resistor 606 can be chosen such that its effective impedance is lower than feedback resistor 210. One skilled in the art will recognize that when resistor 606 with a lower impedance is placed in parallel to feedback resistor 210, the maximum feedback current can be increased which then causes the effective gain of operational amplifier 204 to be reduced. When the effective gain of amplifier 210 is reduced, the amount of time required for operational amplifier 204 to recover from a saturation event can be reduced. In other embodiments, resistor 606 can be replaced by any electrical component whose impedance characteristics cause operational amplifier 204 to recover from saturation more quickly.

FIG. 6B shows yet another embodiment of the implementation shown in FIG. 6A. In this implementation demodulation is performed digitally after filtering and digitizing Vout using an anti-alias filter (AAF) 612 and analog to digital converter 614 (ADC), respectively. An ADC OVERFLOW DETECTION AND CLAMP LOGIC block can monitor the output of the ADC and can assert signal CLAMP_EN to close the feedback switch when the ADC output exceeds a programmable threshold NTRIGGER. The ADC OVERFLOW DETECTION AND CLAMP LOGIC block 610 can keep signal CLAMP_EN asserted until the ADC output level has dropped below a programmable recovery threshold NRECOVER and can perform various other function, such as rejection of narrow noise glitches that are at or close or slightly above the sense amplifiers clamp trigger threshold. The trigger and/or recovery thresholds may be adaptively adjusted to improve touch noise performance in a given environment. Advantage of this scheme is that additional analog blocks, such as comparators, are not required and clamp signal generation can be digital.

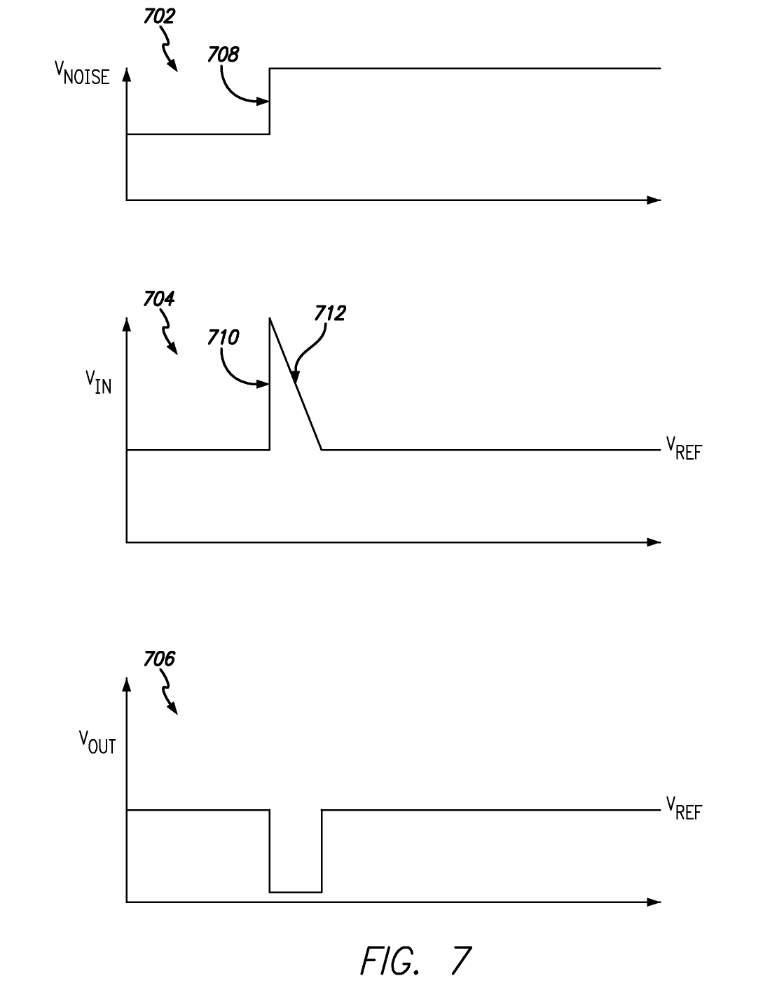

FIG. 7 illustrates an exemplary plot of various signals of the touch sensor panel sense circuit with a switchable resistor according to one disclosed embodiment. Plot 702 represents Vnoise as a function of time. Similar to plot 302 of FIG. 3, Vnoise can experience a nearly instantaneous rise in level, which can create a positive edge 708. Plot 704 represents the corresponding Vin for operational amplifier 204. The positive edge 508 of plot 502 can create a nearly instantaneous spike 710 in Vin. When Vin experiences spike 710, operational amplifier can go into saturation and may be unable to detect touch signals. However when Vin experiences spike 710, comparator circuit 602 can alert processor 606, which can then engage switch 604, thus placing resistor 606 in parallel to feedback resistor 210. This operation can cause operational amplifier 204 to be able to recover from saturation faster, meaning that the slope 712 of plot 704 will be steeper than slope 312 of plot 304. A faster recovery from saturation means that operational amplifier 204 can regain its ability to sense signals indicative of touch faster. As indicated by plot 706, Vout returns to Vref quicker than the Vout displayed in plot 306, indicating that the touch sense circuitry can return to detecting touch signals quicker.

While the methods discussed above can work to ensure that operational amplifier 204 can recover from saturation quickly, so that the ability to detect touch signals is restored quickly, nonetheless the ability to detect touch signals can be compromised for the duration that operational amplifier 204 is in saturation, meaning any touch data processed during the time that saturation is occurring can result in erroneous touch data.

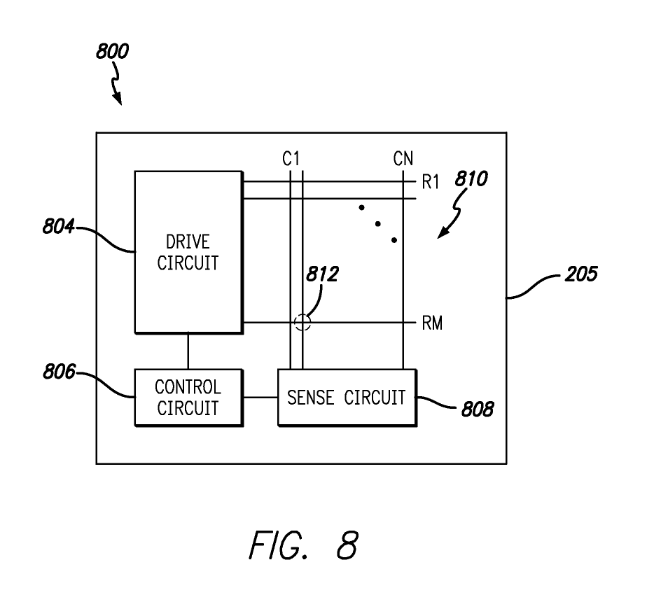

FIG. 8 illustrates an exemplary touch sensor panel control system according to one disclosed embodiment. Touch sensor panel control system 800 can include capacitive array 810, which can be formed by overlapping conductive traces Cl through CN and R1 through RM which form an M×X capacitive array. Control circuit 806 can configure drive circuit 804 to drive one (or a few) rows of array 810 at a time, and sense circuit 808 can capture touch node signal values of a given row. When this operation is complete for a first row (or group of rows), control circuit 806 can then configure drive circuit 804 to drive a next row (or group of rows), and sense circuit 808 can capture touch node values associated with the newly driven row(s). This process can be repeated under the control of control circuit 806, until all node values in array 810 have been captured. The ensemble of pixel values is referred to as an image or frame.

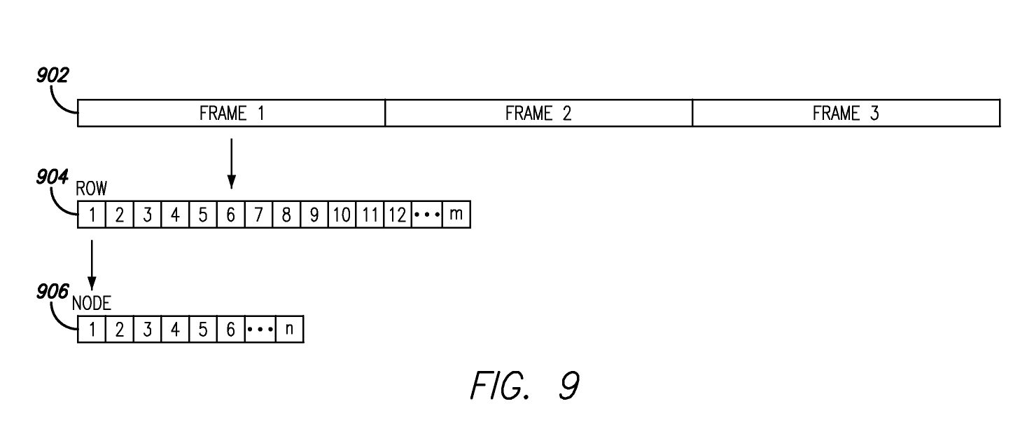

FIG. 9 illustrates an exemplary touch data organization scheme according to one disclosed embodiment. Each individual frame 902 can represent one scan of the entire capacitive array 810. After frame 1 is acquired by touch sensor panel control system 800, the control system can acquire frame 2, 3, 4, etc. during operation of the touch input device. Each individual frame 902 can be composed of row data 904. Control system 800 can drive each row of the array 810 either one at a time or in groups, and can collect the data until a frame is complete. Thus, for an M×X array (M rows, and N columns) frame 902 can include M sets of row data 904. Each individual set of row data 904 can include N sets of node data 906.

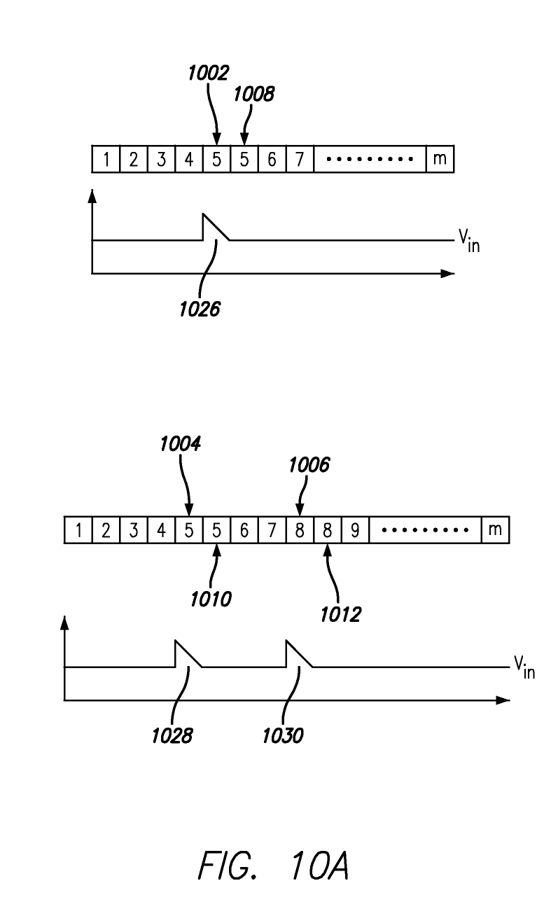

FIG. 10a illustrates one exemplary method of correcting touch data according to one disclosed embodiment. As discussed above, frame 902 can contain M sets of row data corresponding to each row in array 810. In the example of FIG. 10a, a saturation event 1026, indicating that operational amplifier 204 may have potentially been saturated, can be detected at the set of row data 904 corresponding to row 5. A saturation event can be detected in numerous ways. As described above, clamping circuit 402 being engaged due to a differential in Vin and Vref, can be indicative of a saturation event. Furthermore a comparator circuit 602 can be used to detect a saturation or potential saturation event or in applications where the touch signal Vout out of the operational amplifier is digitized by an ADC prior to demodulation, the ADC output can be monitored for an overflow condition. A signal indicative of a saturation event can be inputted into processor 606. Processor 606 can then signal to control circuit 806 that a saturation event has occurred. In the present example, control circuit 806 has received a signal from processor 606 indicating that a saturation event 1026 has occurred during the time period associated with the acquisition of row 5, creating a corrupted row data set 1002. Control circuit 806 then, instead of acquiring the next row in the sequence, can re-acquire row 5 as illustrated at 1008, and discard the data taken during saturation event 1026.

If, during acquisition of a frame, there are multiple saturation events detected, then each potentially corrupted set of row data can be re-acquired. For instance if a saturation detection event is detected at 1028 corresponding to the acquisition of row 5 creating a corrupted row data set 1004, then control circuit 806 can reacquire row 5 as illustrated at 1010. Control circuit 806 then can move on to acquire row 6, 7 and so forth once it has reacquired row 5. However, if a saturation event 1030 occurs during the time period for acquiring row 8 creating a corrupted row data set 1006, then control circuit 806 can again cease the sequential acquisition of row data and re-acquire row 8 as illustrated at 1012. This process can continue until all M rows of the array are acquired.

FIG. 10b illustrates yet another exemplary method of correcting touch data according to one disclosed embodiment. Similar to the embodiment disclosed in FIG. 10a, a saturation event can be detected at 1022, corresponding to the acquisition of data for row 5 and creating a corrupted row data set 1002. However, in this embodiment, control circuit 806 can continue with its sequential acquisition of row data until it finishes acquiring all M rows in a frame. Once all M rows are acquired, control circuit 806 can then re-acquire the rows that have been corrupted by a possible saturation event, and thus in the present example, the control circuit can reacquire data for row 5 at 1008, and can discard the previous row 5 data that was acquired during saturation event 1020. Once the control circuit has reacquired the corrupted row data, it can then begin the process of acquiring the next frame. If there are multiple saturation events during row data such as those shown at 1022 and 1024 corresponding to the acquisition of rows 5 and 8, and creating corrupted row data sets 1004 and 1006, then rows 5 and 8 can be reacquired after the control circuit has finished acquiring data for all m rows of the frame as shown at 1016 and 1018.

In some embodiments the re-acquisition of data can be combined with returning an operational amplifier 204 to a non-saturation state in order to correct for the effects of common mode noise. In some embodiments, the comparator circuit 602, the control circuit 806 and processor 606 can be collectively be called an error reduction circuit. In other embodiments, clamping circuit 402 can be connected to processor 606, and in conjunction with control circuit 806 can be called an error reduction circuit.

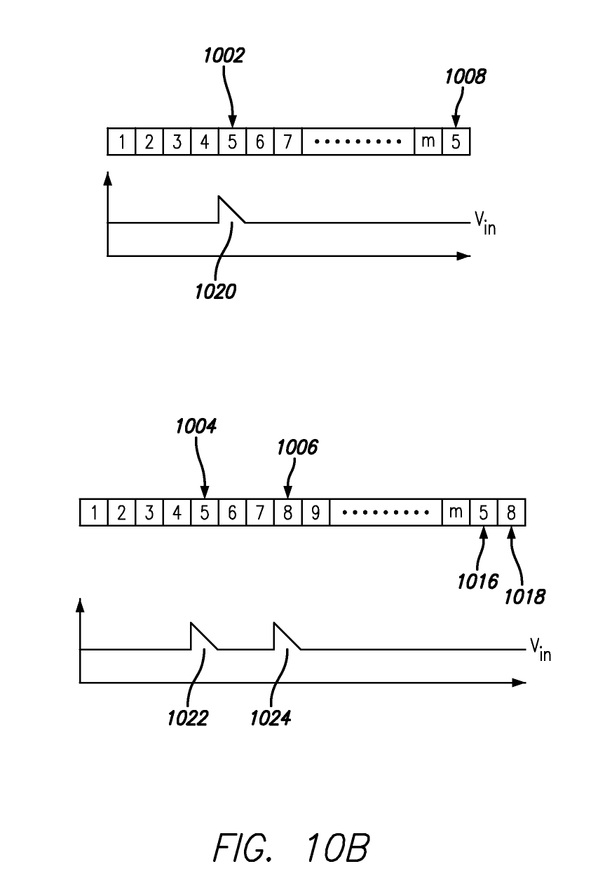

FIG. 11 illustrates exemplary computing system 1100 that can include one or more of the embodiments described above. Computing system 1100 can include one or more panel processors 1102 and peripherals 1104, and panel subsystem 1106. Peripherals 1104 can include, but are not limited to, random access memory (RAM) or other types of memory or storage, watchdog timers and the like. Panel subsystem 1106 can include, but is not limited to, one or more sense channels 1108 which can utilize operational amplifiers that can be configured to minimize saturation time, channel scan logic 1110 and driver logic 1114. Channel scan logic 1110 can access RAM 1112, autonomously read data from the sense channels and provide control for the sense channels including reacquiring data from the sense channels when a saturation event has been detected. In addition, channel scan logic 1110 can control driver logic 1114 to generate stimulation signals 1116 at various frequencies and phases that can be selectively applied to drive lines of touch sensor panel 1124. In some embodiments, panel subsystem 1106, panel processor 1102 and peripherals 1104 can be integrated into a single application specific integrated circuit (ASIC).

Touch sensor panel 1124 can include a capacitive sensing medium having a plurality of drive lines and a plurality of sense lines, although other sensing media can also be used. Each intersection of drive and sense lines can represent a capacitive sensing node and can be viewed as picture element (node) 1126, which can be particularly useful when touch sensor panel 1124 is viewed as capturing an “image” of touch. (In other words, after panel subsystem 606 has determined whether a touch event has been detected at each touch sensor in the touch sensor panel, the pattern of touch sensors in the multi-touch panel at which a touch event occurred can be viewed as an “image” of touch (e.g. a pattern of fingers touching the panel).) Each sense line of touch sensor panel 1124 can drive sense channel 1108 (also referred to herein as an event detection and demodulation circuit) in panel subsystem 1106.

Computing system 1100 can also include host processor 1128 for receiving outputs from panel processor 1102 and performing actions based on the outputs that can include, but are not limited to, moving an object such as a cursor or pointer, scrolling or panning, adjusting control settings, opening a file or document, viewing a menu, making a selection, executing instructions, operating a peripheral device coupled to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 1128 can also perform additional functions that may not be related to panel processing, and can be coupled to program storage 1132 and display device 630 such as an LCD display for providing a UI to a user of the device. Display device 630 together with touch sensor panel 1124, when located partially or entirely under the touch sensor panel, can form touch screen 1118.

Note that one or more of the functions described above can be performed by firmware stored in memory (e.g. one of the peripherals 1104 in FIG. 11) and executed by panel processor 1102, or stored in program storage 1132 and executed by host processor 1128. The firmware can also be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer-readable storage medium” can be any medium that can contain or store the program for use by or in connection with the instruction execution system, apparatus, or device. The computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport readable medium can include, but is not limited to, an electronic, magnetic, optical, electromagnetic or infrared wired or wireless propagation medium.

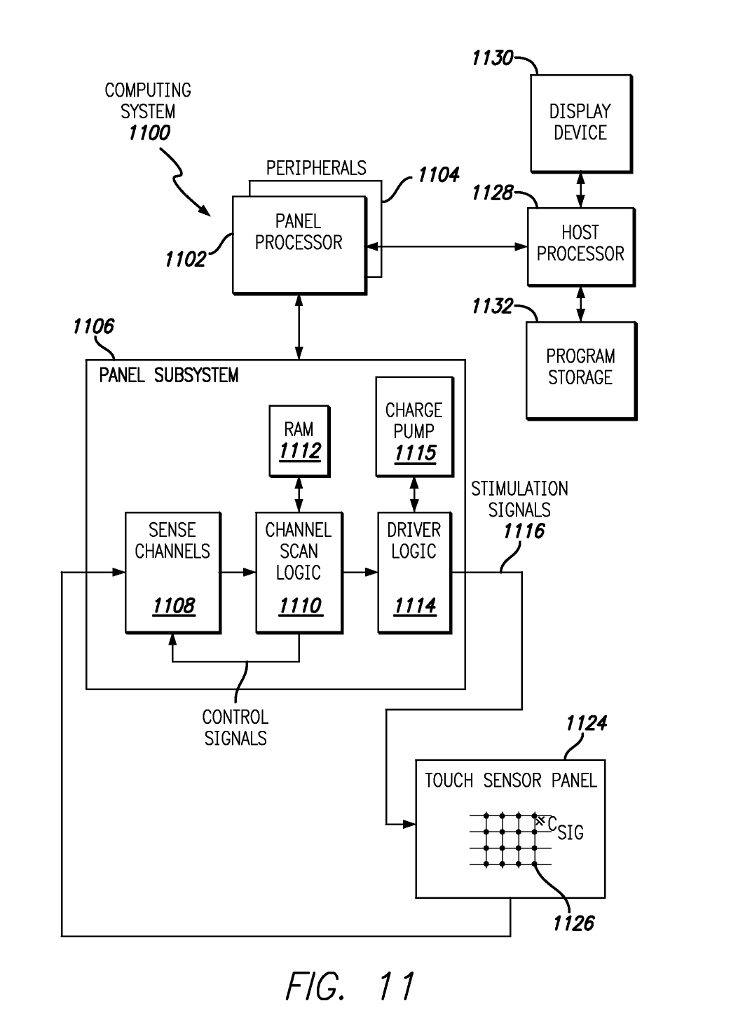

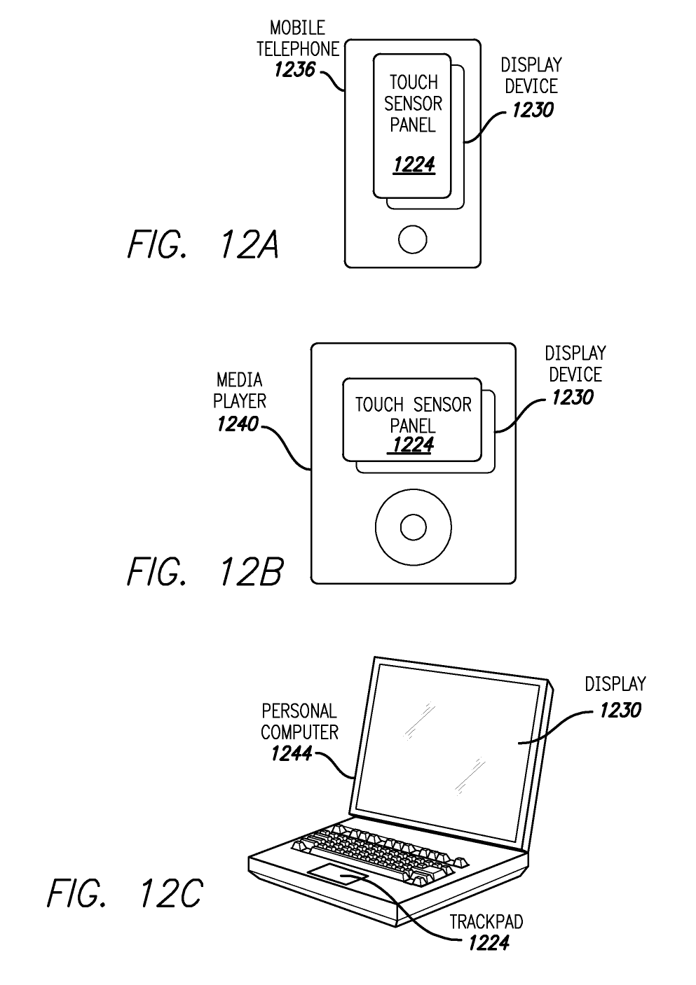

FIG. 12a illustrates exemplary mobile telephone 1236 that can include touch sensor panel 1224 and display device 1230, the touch sensor panel including circuitry to recover from common mode noise events and improved scan logic to mitigate corruption of data due to common mode noise events according to one disclosed embodiment.

FIG. 12b illustrates exemplary digital media player 1240 that can include touch sensor panel 1224 and display device 1230, the touch sensor panel including circuitry to recover from common mode noise events and improved scan logic to mitigate corruption of data due to common mode noise events according to one disclosed embodiment.

FIG. 12c illustrates exemplary personal computer 1244 that can include touch sensor panel (trackpad) 1224 and display 1230, the touch sensor panel and/or display of the personal computer (in embodiments where the display is part of a touch screen) including circuitry to recover from common mode noise events and improved scan logic to mitigate corruption of data due to common mode noise events according to one disclosed embodiment. The mobile telephone, media player and personal computer of FIGS. 12a, 12b and 12c can achieve improved overall reliability by utilizing the common mode noise recovery circuit and improved scan logic according to one disclosed embodiment. The common mode noise recovery circuitry and improved scan logic can serve to improve the performance of touch detection by ensuring that either the amount of touch data corrupted by common mode noise is minimized, or ensuring that no data that is acquired during a common mode noise event is used to determine the presence of a touch or proximity event.

Although FIGS. 12a-c discuss a mobile telephone, a media player and a personal computer respectively, the disclosure is not so restricted and the touch sensor panel can be included on a tablet computer, a television, or any other device which utilizes the touch sensor panel including circuitry to recover from common mode noise events and improved scan logic to mitigate corruption of data due to common mode noise events.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

What is claimed is:

1: A method of reducing common mode noise effects on a touch sensor panel, the method comprising:
monitoring a touch sensing circuitry for a possible saturation event; and
reducing a touch signal error if the possible saturation event is detected at the touch sensing circuitry.

2: The method of claim 1, further comprising detecting the possible saturation event by activating a clamping circuit at an input of the touch sensing circuitry when a magnitude of an input signal of the touch sensing circuitry is above a pre-determined threshold.

3: The method of claim 1, further comprising detecting the possible saturation event by comparing a difference between a plurality of inputs on an operational amplifier in the touch sensing circuitry and determining if the difference between the plurality of inputs exceeds a pre-determined threshold.

4: The method of claim 1, further comprising detecting the possible saturation event by comparing an output of the operational amplifier in the touch sensing circuitry, to a supply voltage of the operational amplifier and determining if the difference between the output and the supply voltage is below a pre-determined threshold.

5: The method of claim 1, further comprising detecting the possible saturation event by monitoring a digitized touch data prior to a demodulation of the touch data and upon exceeding a first threshold, applying a feedback switch to lower a feedback impedance of the operational amplifier and opening the feedback switch after a time has passed or the digitized touch data has dropped below a second threshold.

6: The method of claim 1, further comprising reducing a touch signal error by applying a clamping circuit when the touch signal exceeds a first voltage threshold and keeping the clamping circuit applied until an operational amplifier output voltage has dropped below a second voltage threshold.

7: The method of claim 1, further comprising reducing the touch signal error by reducing a time that the touch sensing circuitry experiences a saturation event.

8: The method of claim 7, further comprising reducing the time that the touch sensing circuitry experiences a saturation event by clamping an input of the touch sensing circuitry.

9: The method of claim 7, further comprising reducing the time that the touch sensing circuitry experiences a saturation event by adjusting a feedback resistance of the touch sensing circuitry.

10: The method of claim 7, further comprising reducing the touch signal error by re-acquiring a plurality of data that has been acquired during the possible saturation event.

11: The method of claim 1, further comprising reducing the touch signal error by re-acquiring a plurality of data that has been acquired during the possible saturation event.

12: The method of claim 11, further comprising re-acquiring the plurality of data after detecting the possible saturation event.

13: The method of claim 11, further comprising re-acquiring the plurality of data after acquiring a frame of data that includes the plurality of data.

14: An apparatus for reducing common mode noise effects on a touch sensor panel, the apparatus comprising:
a touch sensor panel;
touch sensing circuitry coupled to the touch sensor panel and configured to detect a possible saturation event; and
a error reduction circuit coupled to the touch sensing circuitry and capable of reducing an error on a plurality of touch signals based on the detected possible saturation event.

15: The apparatus of claim 14, the error reduction circuit comprising a clamping circuit configured to activate when an input to the touch sensing circuitry exceeds a pre-determined threshold indicative of the possible saturation event.

16: The apparatus of claim 14, the touch sensing circuitry comprising a comparator circuit configured to compare a plurality of signals of the touch sensing circuit to detect the possible saturation event.

17: The apparatus of claim 14, the error reduction circuit capable of reducing an error on the plurality of signals by reducing a duration of the possible saturation event.

18: The apparatus of claim 17, the error reduction circuit capable of reducing the duration of the possible saturation event by changing a feedback resistance of the touch sensing circuitry.

19: The apparatus of claim 17, the error reduction circuit capable of repeating a measurement of the plurality of touch signals if the possible saturation event occurred during a measurement of the plurality of touch signals.

20: The apparatus of claim 14, the error reduction circuit capable of repeating a measurement of the plurality of touch signals if the possible saturation event occurred during a measurement of the plurality of touch signals.

21: A non-transitory computer readable storage medium having stored thereon a set of instructions for reducing common mode noise effects on a touch sensor panel, that when executed by a processor causes the processor to:
detect a possible saturation event; and
reduce an error on a touch signal based on the detected possible saturation event.

22: The non-transitory computer readable storage medium of claim 21, wherein the instructions further cause the processor to detect a possible saturation event by detecting an output of a comparator circuit coupled to touch sensing circuitry.

23: The non-transitory computer readable storage medium of claim 21, wherein the instructions further cause the processor to reduce an error on a touch signal by reducing an amount of time that an operational amplifier of the touch sensing circuitry remains in saturation.

24: The non-transitory computer readable storage medium of claim 23, wherein the instructions further cause the processor to reduce an amount of time that an operational amplifier of the touch sensing circuitry remains in saturation by changing a net feedback resistance of the operational amplifier.

25: The non-transitory computer readable storage medium of claim 23, wherein the instructions further cause the processor to reduce an error on the touch signal by re-acquiring a plurality of data collected during the detected possible saturation event.

26: The non-transitory computer readable storage medium of claim 21, wherein the instructions further cause the processor to reduce an error on the touch signal by re-acquiring a plurality of data collected during the detected possible saturation event.
